(19) United States
(12) Patent Application Publication
(10) Pub. No.: US 2020/0065601 A1
(43) Pub. Date: Feb. 27, 2020

(54) METHOD AND SYSTEM FOR TRANSFORMING HANDWRITTEN TEXT TO DIGITAL INK

(71) Applicant: BJA HOLDING AS, Finnsnes (NO)

(72) Inventor: Bengt ANDREASSEN, Kaldfarnes (NO)

(21) Appl. No.: 16/346,822

(22) PCT Filed: Nov. 1, 2017
(86) PCT No.: PCT/NO2017/050280

§ 371 Date: May 1, 2019

(30) Foreign Application Priority Data
Nov. 1, 2016 (NO) 20161728

(51) Int. Cl. G06K 9/22; G06K 9/00

(52) U.S. Cl. CPC G06K 9/222; G06K 9/00872; G06K 2209/013; G06K 9/00416; G06K 9/00449

(57) ABSTRACT

Written text transform relating to a method and system for text recognition and in particular for transforming liquid ink (handwritten text) to digital ink, which subsequently may be analyzed by a processor, comprising segmenting a scan image and vectorizing the segment, analyzing the vectors and building individual strokes, analyzing the strokes and determining a start point and direction of writing for each stroke.

### CROSS-REFERENCE TO RELATED APPLICATIONS

This application is a 35 U.S.C. § 371 National Phase of PCT Application No. PCT/NO2017/050280 filed Nov. 1, 2017, which claims priority to Norwegian Patent Application No. NO 20161728 filed Nov. 1, 2016. The disclosures of these applications are incorporated in their entireties herein by reference.

### BACKGROUND

Present invention relates to a method and system for text recognition and in particular for transforming liquid ink (handwritten text) to digital ink, which subsequently may be analyzed by a processor.

### SUMMARY

There exists digitalization processes providing reliable transforming of machine typed text into a digital format.

There also exists transforming tools for transforming handwritten text typed in on digital paper, such as touch sensitive screens as seen on smart phones and tablet computers, such as iPad.

There also exists transforming tools for transforming handwritten text on paper into a digital format. There is however a problem with transformation of handwritten text which is written in “free hand” notation, and not strictly following specified rule sets defined by the analyzing tool.

Problems are specifically related to analyzing continuous lower case cursive characters, writing styles, and languages having a character set comprising letters and diacritic marks, even multiple diacritic marks.

It is an aim for the invention to provide a solution for the above stated problems, and provide a system and method for converting hand written text to digital text without the constraints associated with this task known today.

In practice the invention will convert Liquid Ink to Digital Ink.

In this document the following phrases and abbreviations are used as follows:

The phrase “text recognition”, shall in this document mean recognition of handwritten text and not printed characters with a certain font-type and font-size.

OCR: Optical Character Recognition—recognition of printed characters.

ICR: Intelligent Character Recognition—recognition of hand written text performed through pattern recognition and matching algorithms on isolated letters written in upper case and/or lower case.

IWR: Intelligent Word Recognition—recognition of hand written text performed through pattern recognition and matching algorithms on letters written in upper case and/or lower case.

Liquid ink: Non-constrained handwritten text or figures on paper, including copies of such, or images of such text or figures, or such images stored in computer readable mediums.

Digital ink: Text written on a digitizing medium comprising to capture in digital format the movement of the pen during writing phase.

Hand written—writing: the hand written or hand drawn text or figures.

Vectorization—vector: The task in vectorization is to convert a two-dimensional image into a two-dimensional vector representation of the image. It is not examining the image and attempting to recognize or extract a three-dimensional model, and the vectorization does not involve optical character recognition. The characters or figures are treated as lines, curves, or filled objects without attaching any significance to them. An advantage is that the shape of the character is preserved, so artistic embellishments remain.

Center line trace: A trace following the center of a line.

Outline trace: A trace defining a volume, for example an inner and an outer circle defining the letter O.

The invention is further explained in the attached figures that should be interpreted as illustrations of possible embodiments of the invention, but do not represent any limitation of the scope of the invention.

### BRIEF DESCRIPTION OF THE DRAWINGS

FIG. 1A illustrates a flowchart showing the integration of the invention into digitization workflow

FIG. 1B illustrates a flowchart showing the process of the module for vector analyzes and stroke building of the present invention

FIGS. 1C, 1D, and 1E illustrates correspondingly character bounding box having h/w “>”, “<”, and “=” 1

FIG. 1F identifies the diagonal angle of the bounding box

FIG. 1G illustrates how the sequence of strokes can be defined.

FIG. 1H identifies the method for defining stroke direction of numbers/digits

FIG. 1I illustrates an example of determining stroke order

FIG. 2A illustrate a form used in Intelligent Character Recognition (ICR)

FIG. 2B illustrate a type of loosely structured written material

FIG. 2C illustrate a type of loosely structured Capital letters written material

FIG. 3A shows an illustration of a handwritten style Vietnamese text

FIG. 3B shows stroke path in the pen movement direction of a section of the text in FIG. 3A

FIG. 3C shows the trace vectors generated from the text in 3A

FIG. 3D shows the trace vectors of 3C converted to ink paths drawn according to hand movements from left to right.

FIG. 4A-4D shows examples of Thai letters and corresponding pen movement directions when handwritten

FIG. 5A is a handwritten Thai sample sentence

FIG. 5B is a raw bitmap image scan of the first symbol in FIG. 5A

FIG. 5C is a stroke path analysis of the symbol in FIG. 5B

FIG. 5D is the sentence of FIG. 5A in ink strokes.

FIG. 6A-C shows a selection of a text and cleanup process

FIG. 7A-E shows how lines are identified as hooks, arks, pen turning points, loops and draw strokes

FIG. 8A-B shows the elimination of unwanted fragments and noise

FIG. 9 illustrates several examples of the invention applied to different types of text examples.

FIG. 10 illustrates a system setup for the present invention.

FIG. 11 illustrates how a multi vector drawing is analyzed and constructed as a two stroke combination.

FIG. 12 A-U illustrates examples of line to circle analysis.

FIG. 13 illustrates an example of Outline trace.

FIG. 14 A-B illustrates when the loop rule is adapted for lines crossing a separation line.

### DETAILED DESCRIPTION

The invention is applied to improve the ability of text recognition.

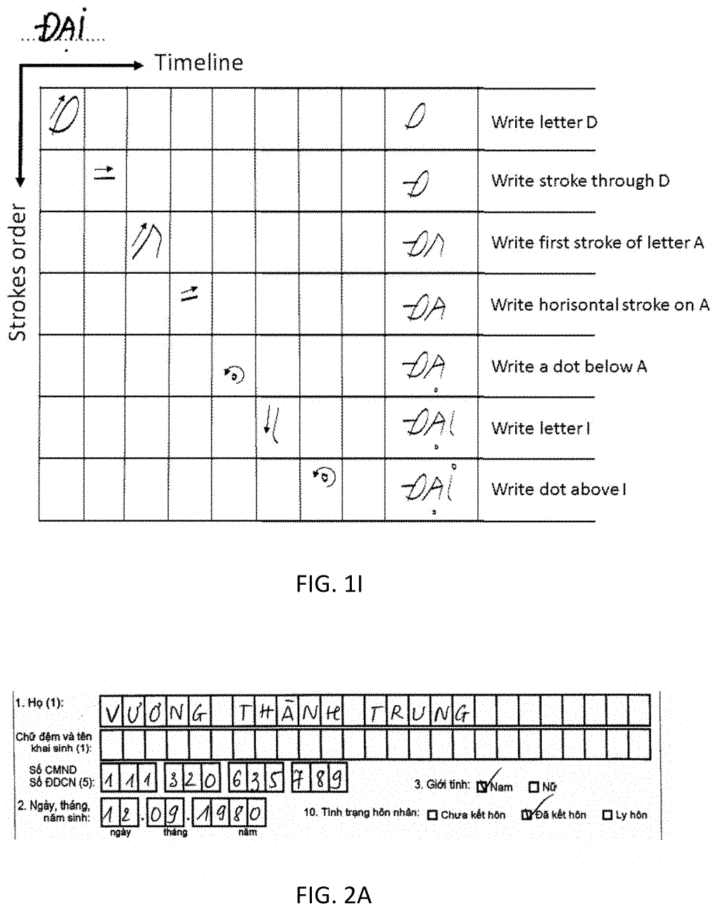

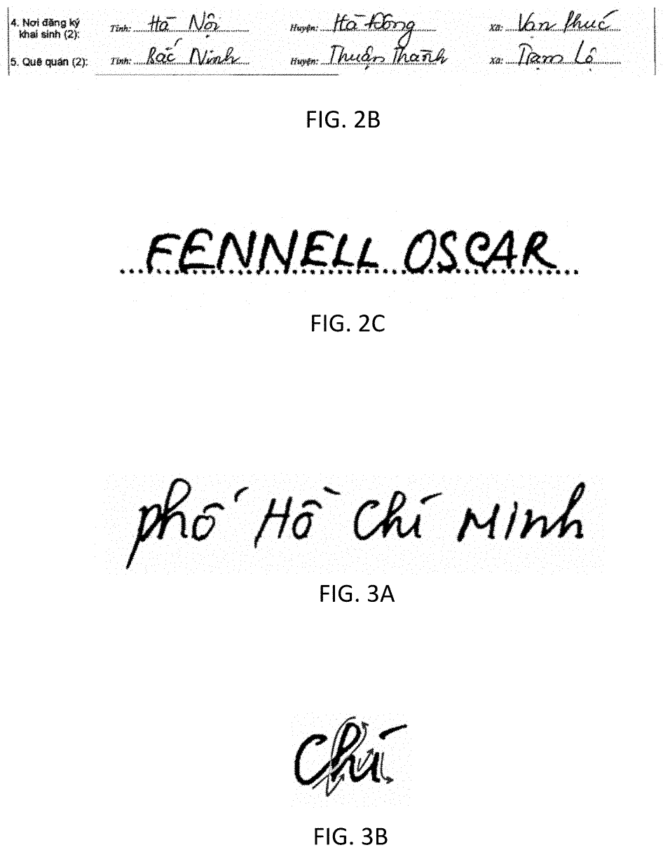

ICR performs best when every character is written within a separate box, often called constrained fields. If the characters are not inside boxes, the characters should be written clearly separated on a straight line as illustrated in FIG. 2C.

Though the constraint fields normally gives high accuracy on character recognition, the boxes is themselves limiting and sometimes does not give enough room for the whole character. Especially this is the case with languages like Vietnamese and Thai.

The biggest problem is when we the designed forms of the constraint fields are not optimized for ICR, or the written material is more loosely structured. In the example shown in FIG. 2B, a specific location for each input is defined, but the characters within the words are not clearly separated as they are written in lowercase cursive.

Normally this is almost impossible to interpret using traditional ICR technology.

Digital Ink refers to a technology that digitally represents handwriting in its natural form. In a typical digital ink system, a digitizer is laid under or over an LCD screen to create an electromagnetic field that can capture the movement of a special-purpose pen, or stylus, and record the movement on the LCD screen. The effect is like writing on paper with liquid ink. When the pen comes in contact with the screen's electromagnetic field, its motion is reflected on the screen as a series of data points. As the pen continues to move across the screen, the digitizer collects information from the pen movement in a process called “sampling”. These electromagnetic pen events are then represented visually on the screen as pen strokes.

When it comes to character or word recognition, Digital Ink is far superior to for example traditional bitmap pattern recognition since a pen is recording movements and “strokes” that gives an extra dimension of information in addition to the shape of the letters.

Many applications are provided in the field of Digital Ink, and it is an aim for the present invention to facilitate a method and a tool for exploiting this multitude of applications also for liquid ink representations not optimized for ICR.

Examples of such liquid ink sources may be ancient birth register, judicial register, yearbooks, free form archives, etc.

The inventions comprises a method and system for reconstruction or simulation of the pen movements from liquid ink on paper, and convert this liquid ink to a format of Digital Ink, and thereby enable utilization of the huge amount of services and applications built around Digital Ink technology.

The present invention analyses the liquid ink to detect and reconstruct the pen movements the writer did when writing the letters, words or signs on the paper.

The key feature of the present invention is to restore the Ink strokes as if they were coordinates captured with an electromagnetic pen, in a mimic of the strokes, in a series of data points equivalent to a pen movement.

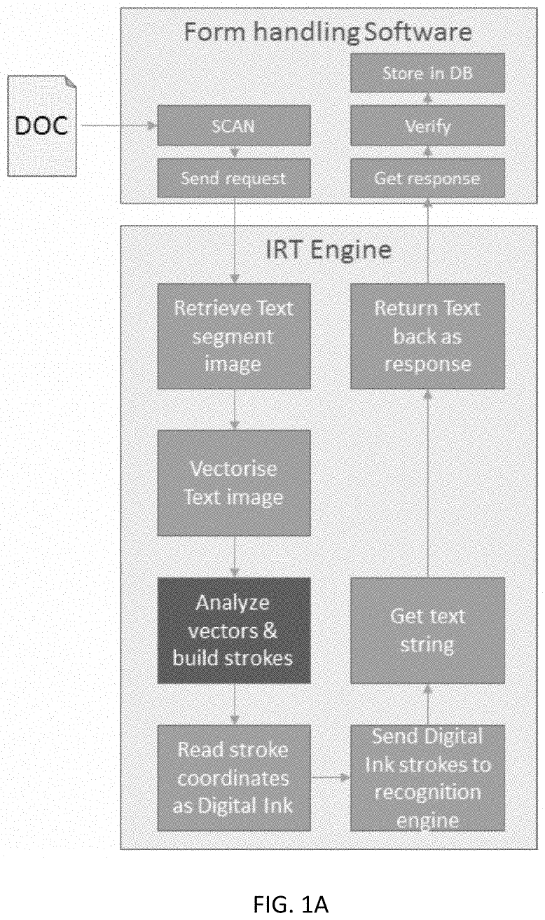

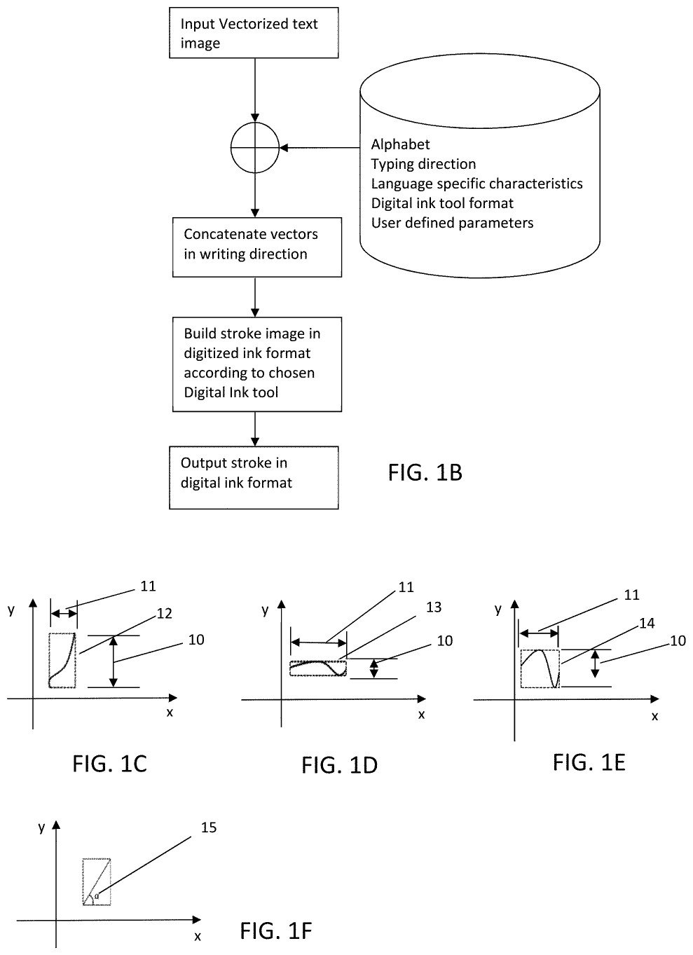

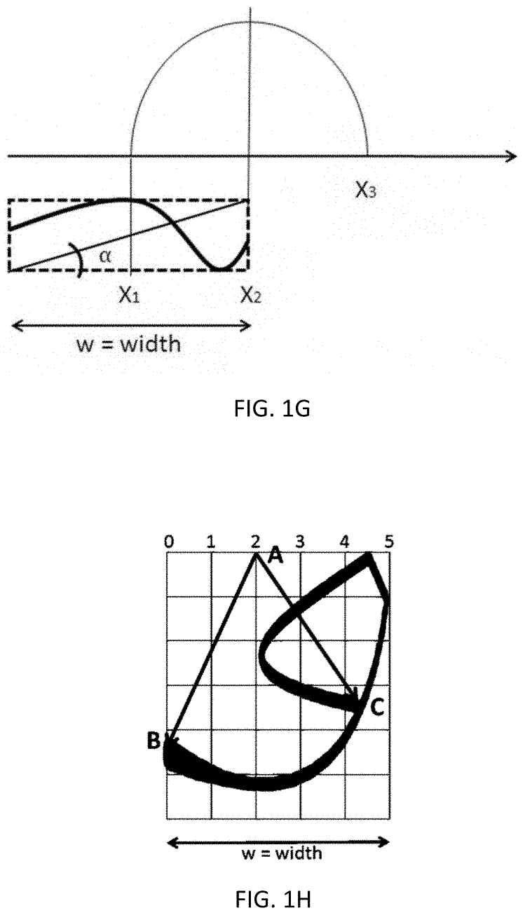

A typical embodiment of the invention is shown in the flowchart illustrated in FIG. 1A, where it is used in a digitalization process of hand written forms.

The document to process is fed into a form handling process, which may be automated, manual or a combination of the two. The form is scanned to provide a scan image, and the scan image is sent to the Ink recovery technology (IRT) engine of the present invention residing in a computer resource.

The IRT is in the embodiment shown in FIG. 1A comprised of several modules where standard or off the shelf executables are combined together with the present invention to provide a tool for automatic digitization of handwritten forms.

The scanned image is fed into a module where the image is split into segments of text images. All segments are then processed by a vectorization module. The output of the vectorized segments is fed into the analyzer of the present invention. The vector analyzer compare each part of the vectorized segments in the light of chosen alphabet characteristics, defined typing direction, written language specific characteristics, digital ink tool format and other style related parameters either defined by chosen alphabet or user. By combing these inputs and analyzing the vectors from the vectorization module, the present invention identifies the pen stroke paths.

A pen stroke is an event starting with a pen hit the paper until it is lifted from the paper, ending the pen stroke. Restoring multiple strokes comprise predicting the path and the movement of the pen or the like on every single stroke.

In a first step the image of the character or figure is vectorized using center trace to provide a 2-dimensional representation of the letters, signs or figures, comprising multiple unrelated vectors as illustrated in FIG. 11. A stroke can consist of one or multiple vectors. A letter, sign or figure can consist of one or multiple strokes. As an example, the letter A as illustrated in FIG. 11 needs to be transformed from 7 vectors into 2 strokes.

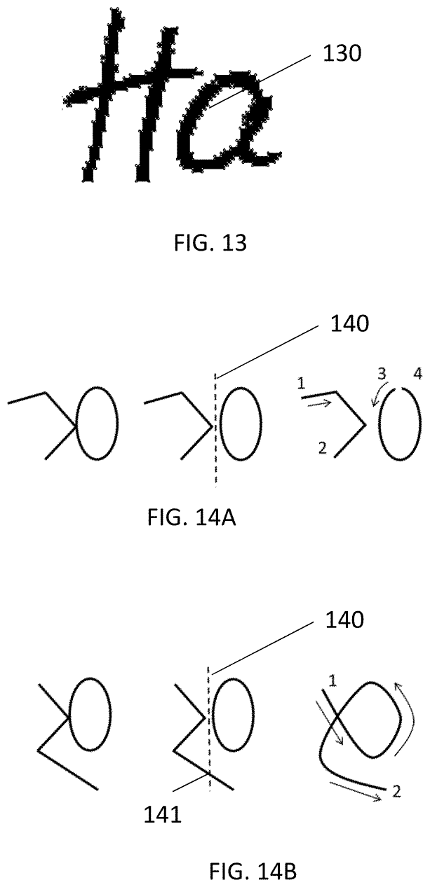

In cases when small dots and circles in letters are important to identify, like building strokes for cursive Latin letters, a second layer comprising outline trace may be used for validation. The inner circle 130 in FIG. 13 will indicate that a closed stroke circle should be drawn around. When small fragments like underline dots are important to detect, outline trace will always be more reliable to use. Outline trace in combination with centerline trace can also be used to validate the thickness or pressure of the stroke.

To rebuilding the stroke, the present invention analyze the vectors and anticipate the start, the path, the direction and where the stroke should end. The process follows different strategies depending on the language of the text or figures, and what type of classes of text within the selected language. This may be either specified in each case, or may also be automatically detected in some instances of implementation of the present invention.

Some examples of details related to different languages or alphabets are listed below, and represent some of the rulesets or approaches for the analyzing performed in the present invention:

Latin numbers, uppercase, lowercase and cursive mixed alpha- or mixed alphanumeric might differ slightly, and the direction of strokes may be evaluated from the shape of a bounding rectangle 12, 13, 14 defining the stroke.

A stroke which is bound by a rectangle having a height 10 taller than width 11, h/w >1, may be considered written from a starting point of the stroke end having the highest Y value to end with lowest Y value if observed in an x/y diagram as illustrated in FIG. 1C.

A stroke fitted in a rectangle 13 which has a width 11 taller than height 10, h/w<1, may be written from a starting point of the stroke end having the lowest X value to end with highest X value as illustrated in FIG. 1D.

When bounding box 14 is square, h/w=1, the point closest to the upper left corner of the bounding box may be the starting point for the stroke as illustrated in FIG. 1E.

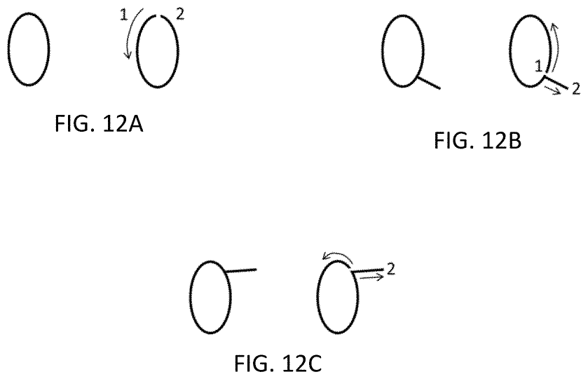

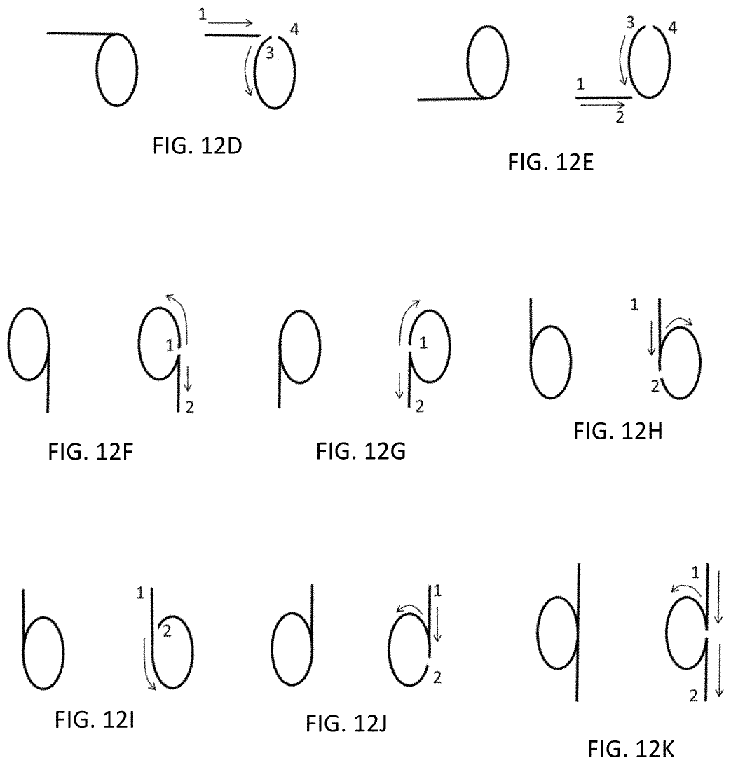

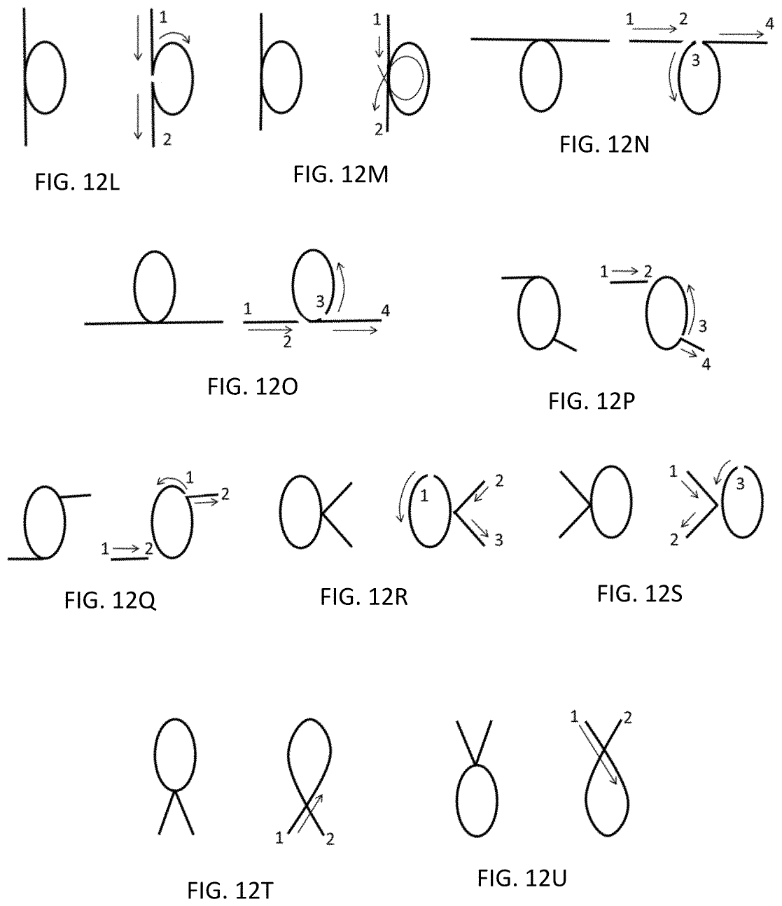

Circle strokes, in form of a closed polygon, and not connected to any other stroke strokes, may be written in anticlockwise direction, starting for example from the topmost position (Max Y value) such as illustrated in FIG. 12A.

When a bounding box is defined for a stroke, the angle α of the diagonal bounding box illustrated in FIG. 1F may be used to define the order of when the different strokes are drawn relative to each other.

The sequence of strokes are then analyzed to be written from left to right based on a rank determined by the highest X value for each stroke (the rightmost position). Straight horizontal strokes are delayed compared to vertical strokes. For Latin uppercase letters a simple sine function is used to adjust the timing of a stroke ranging from a vertical formed stroke to a horizontal formed stroke. An example of a visualization of a stoke order estimation for the stroke sequence is illustrated in FIG. 1G.

The formula calculating the order delay may be defined as:

K=(X2+w/2)−(w*Sin(α)) (1),

wherein K is the delay, X2 is the largest x-dimension value of the stroke bounded by the bounding box, w is the length of the stroke in the x-axis dimension, and a is the angle of the diagonal of the bounding box from lower left corner to upper right corner. Other formulas may be used depending on writing styles and directions.

K will always be calculated as a value in the sequence frame:

X1<=K<=X3 (2)

Using the formula (1) for a perfect vertical stroke will give an K=X1, which is the x-position of the vertical centerline of the bounding rectangular box. A perfect horizontal stroke will give a K=X3, which is the x-position w/2 higher than the rightmost x-position of the bounding box. For example the horizontal line in the H, “−”, will then most likely be written after the two vertical lines. For dots and markers below or above text baseline, a delay is added so it will be written just after strokes existing in the same vertical space. Dots are assumed to be a diacritic dot below character (for Vietnamese) or dots above, for example dot above J or I. If a baseline is detected and dot is on baseline, or there is no strokes below or above in vertical space, dots are assumed to be a period and then not delayed.

In the same manner there will be different strategies for languages like Thai, Chinese, Japanese or Arabic. For

Thai language it may be advantageous to start building the stokes from the first circle or loop on each character and for Latin characters strokes mostly starts from top-left to bottom-right.

Cursive written Latin text is challenging to recognize with conventional methods due to the lack of separation between letters. Using Digital Ink solves much of this limitation because text recognition engines evaluate movements. Present invention differs for example from existing methods for bitmap character recognition in that when converting cursive written Latin text into Digital Ink when handling of loops, curves and circles.

Examples of line to circle analysis are illustrated in FIG. 12B to 12U. All figures as illustrated in FIG. 12A to 12U shows written liquid ink as observed on left side figure, and how the stroke is analyzed and built in present invention on right side figure. The strokes are drawn from 1 to 2 and in some cases continue from 3 to 4.

When a line is connected to a circle, the circle is normally drawn counter clockwise, except when vertical lines are connected on left side and characters are not numerical. FIGS. 12M and 12H illustrate rules for numbers, and FIGS. 12G, 12H and 12L illustrates rules for cursive letters.

Horizontal incoming lines from left side may be disconnected as illustrated in FIGS. 12D, 12E, 12N, 12O, 12P and 12Q.

Two lines that connect at one single point to left or right side of a circle as illustrated in FIGS. 12R and 12S may be disconnected if both line segments after disconnection will be completely vertically separated from the circle. If lines continue above or below the circle, the loop rule will be applied.

This is further exemplified in FIG. 14 A identifying the separation line 140 when the connecting lines connected to the circle is moved left wise, and the connecting lines do not cross the separation line 140, and in FIG. 14 B the case is illustrated when, after detachment, the connecting lines do cross the separation line 140 in a crossing point 141.

Two lines that connect at one single point on bottom or top of a circle will follow the loop rule as illustrated in FIGS. 12T and 12U.

The stroke order analyzing sequence is exemplified in FIG. 1I where the first letter show how the “D” and the “−” will be written in the order “D” first and “−” second, even if the element with the left most position is the “−”. The pen direction illustrated may be predefined in the alphabet characteristics of the language being analyzed, and may vary for different writing styles.

It may for example be possible to define different writing styles for right hand writing and left hand writing. The alphabet characteristics may be synchronized with the digital ink tool used.

Both Thai and Latin order the characters from left to right.

The invention comprises the ability to analyze different types of characters and numbers (digits) using individual analyzing strategies to define starting point of stroke. For numbers this may follow the following strategy as supported by FIG. 1H, wherein:

A=w*2/5 (3),

Wherein A is a predefined measuring point on the upper left rectangle side of the bounding box. The end points of the dumber/digit is measured between measuring point A and the end point.

Starting position of the stroke is then selected to be the stroke end position that has the shortest distance to A. In FIG. 1H, the end point B has a longer distance to A than the end point C, thereby the stroke starts in C and is drawn towards B.

When analyzing a text or figure, it is necessary to define what the natural writing direction and − rules are for the subject being analyzed. This is predefined for each analyzing session.

The present invention does not need to know what specific letters, figures or signs are being analyzed since the only concern is the reconstruction of the pen movements. The strokes will when constructed form basis as input to 3^{rd} party digital ink recognition tools or services that will interpret the strokes and convert those into letters, words, numbers, dates or signs.

When the present invention analyze the stroke it is important to predict the movement of the pen.

In one embodiment of the invention a method for creation of the pen stokes start with a centerline vectorization of a black and white bitmap image of the text written with liquid ink. The vectors will visually represent the shape of the text or figure, but all vectors will likely be unrelated and randomly ordered. The purpose of the vectorization is to make initial guidelines for predicting pen strokes.

According to a selected language character set and parameters, and optionally a subset within this language domain, a predefined strategy is selected.

The method starts with reading the coordinates of the vectors from the side that defines the writing direction for the language.

For each line or vector, defined by two end points, a prediction of what is the next point is performed. If one or more points are found in the predicted direction, then the new points are nested to the previous, thereby building up a stroke with a certain length and direction.

If two vectors have a certain angle between them, it is assumed that the next point may follow on the same curve or path as defined by the previous difference/path.

When next possible connection consist of more than one option the prediction may use as many as possible of previous collected points to predict the next connection.

Multiple points collected to a stroke may, when being detected as following a curve equation, be used to predict next point in the same curve.

If there are no new points in the predicted direction, it may be investigated whether there are an intersection point at a point in the stroke that has already been passed. If finding a vector with a common point (intersection) one or more points behind, an additional path is generated in the opposite direction and the “Pen” is moved out on the new path defined by the intersection line.

If the line meets a collection of vectors defining a full circle, it is checked whether there is a second line having and intersection at same point. If two lines exists having same intersection point on circle, the stroke is continued to form a loop, following around the circle and exit out on the second line connected to the circle.

For each pen stroke, the analyzing of the correct stroke movement direction is done when the pen stroke ends.

The output from the analyzer of the present invention is formatted in accordance with a chosen digital ink analyzer module. The written text from the form which was liquid ink has now got a representation similar to a corresponding text written with Digital Ink. The next modules are then based on the text recognition tool of the chosen Digital Ink recognition engine, and the text recognition module forward the converted text to the output module. The output from the IRT engine is then fed into the Form handling process, and data may be stored in a database or similar.

The process of the analyzing of the vectors and stroke building is illustrated in the flow chart in FIG. 1B. The vectorized text image is received from the module performing the vectorization. This input is combined with the chosen alphabet characteristics, and the writing direction of the selected language. The vectors from the input is analyzed and cleaned up, for example deleting elements not likely to represent part of the text.

The vectors that are considered to be linked are then concatenated, and separate vectors representing for example diacritic marks are represented as standalone strokes.

The stroke image is formatted according to the format of the chosen Digital Ink tool format specification, and then output to the Digital Ink tool module.

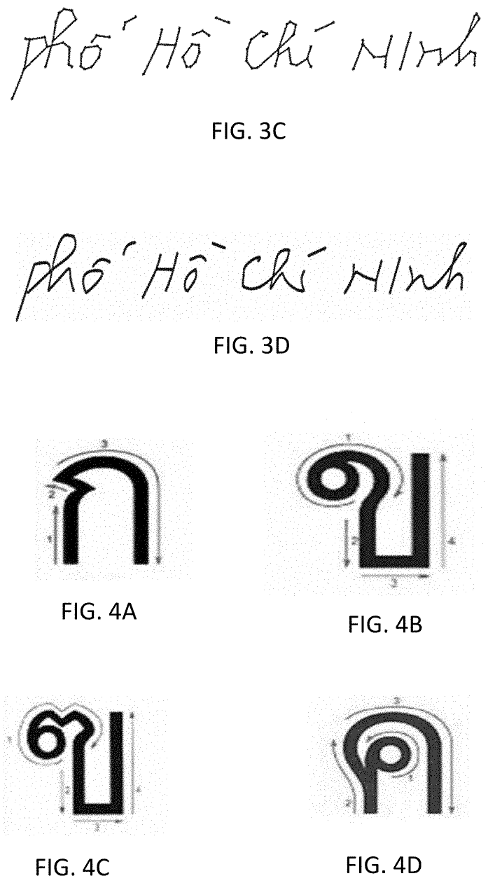

In FIG. 3A an example of a scan of a Vietnamese text string is provided. The scan was performed from paper at 300 dpi.

The use of double diacritic marks in the Vietnamese language is an aspect that makes ICR specifically challenging.

The pen stroke path is built by analyzing or predicting the direction and movement of the pen. In FIG. 3B this task is illustrated by the arrows in conjunction with the third word in the text from FIG. 3A. In the text displayed in FIG. 3B it is important to map the movement path of the loop contour of the “h”.

A vector representation of the analyzed whole text string shown in FIG. 3A is shown in FIG. 3C. In this example the ink path of the vectors combined, built up from multiple single line vectors, draw the strokes as estimated hand movements from left to right. This vector representation can then be formatted and fed into a Digital ink tool, such as for example in the format of “Ink Serialized Format Specification” from Microsoft® which makes it possible to export/save Ink strokes, and opposite, restore these back into strokes on screen.

It is thus possible to get a close to perfect result without identifying the actual characters or even get all stroke paths correct, since the tools analyzing the output of the vectorization will have built in error correction and detection.

The characterizing feature of the present invention is to identify a possible path of the ink defining the characters, numbers, words and figures/signs in the analyzed text.

In the case of the analyzing of the diacritic marks the present invention provides a further characterizing effect that all strokes are vectorized as they are written, without deciding what character the individual diacritic mark belongs to. As long as the vectorization and the chosen writing direction of the vectors are cleaned up according to the selected alphabet and fed to the Digital Ink tool, it will be analyzed and determined which character it belongs to there. This will also solve the problem with double diacritic marks which is representing a considerable challenge for all ICR tools.

The resulting text string when converted to Digital ink is shown in FIG. 3D, and the digital representation when fed to the handwriting recognition procedure of the Digital Ink tool is:

PH [symbol] H [symbol] CH [symbol] MINH (4)

The present invention is close to language independent, as long as it is possible to predict the original pen movements of the writer. Character recognition will depend on the languages supported by the chosen Digital Ink recognition engine.

In another special language alphabet, the Thai language, there are a different challenge that are characteristic of the alphabet, the loops, and that all characters mostly start with a first loop/circle as shown in FIG. 4A-D. The figures have numbered arrows to define the order and direction of the stroke.

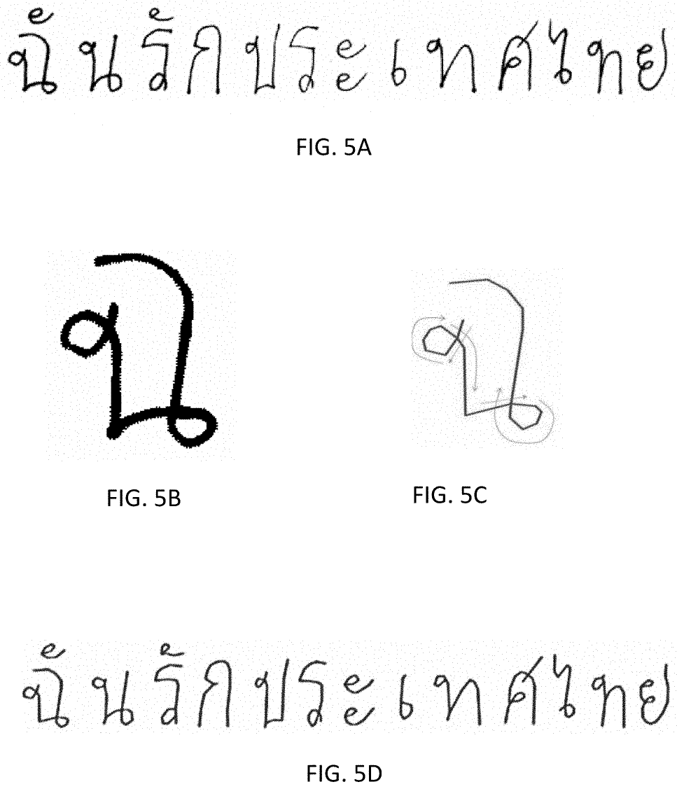

FIG. 5A shows a Thai text string. When the text string in 5A is scanned the first sign is shown in FIG. 5B. When the sign is run through the vectorization module of the invention, it may be represented as illustrated in FIG. 5C, wherein the first loop is detected on the left part of the sign, and the estimated pen movement is illustrated with the 21 straight line vectors concatenated to form a continuous line from start to end of the sign.

In FIG. 5B the image quality is emphasized to illustrate that any disturbing elements will degrade the recognition. Examples of unwanted elements are visible paper structure or lines and dots that interfere with the letter.

FIG. 5D show the whole sentence from the image converted to ink strokes, and testing this ink strokes against the 3rd party recognition engine returns: [symbol] (5)

This is 100% match.

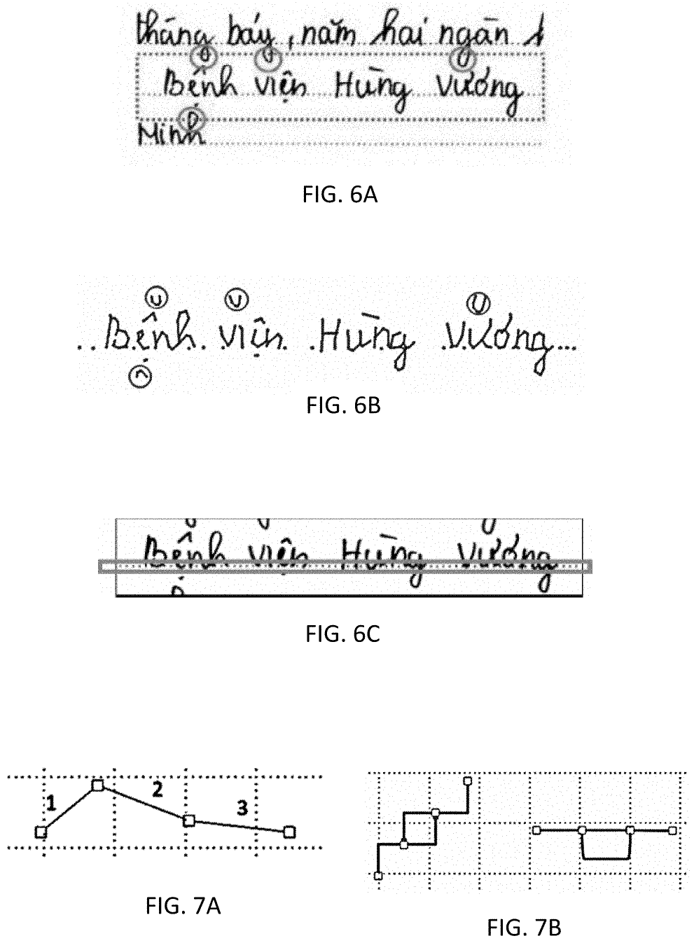

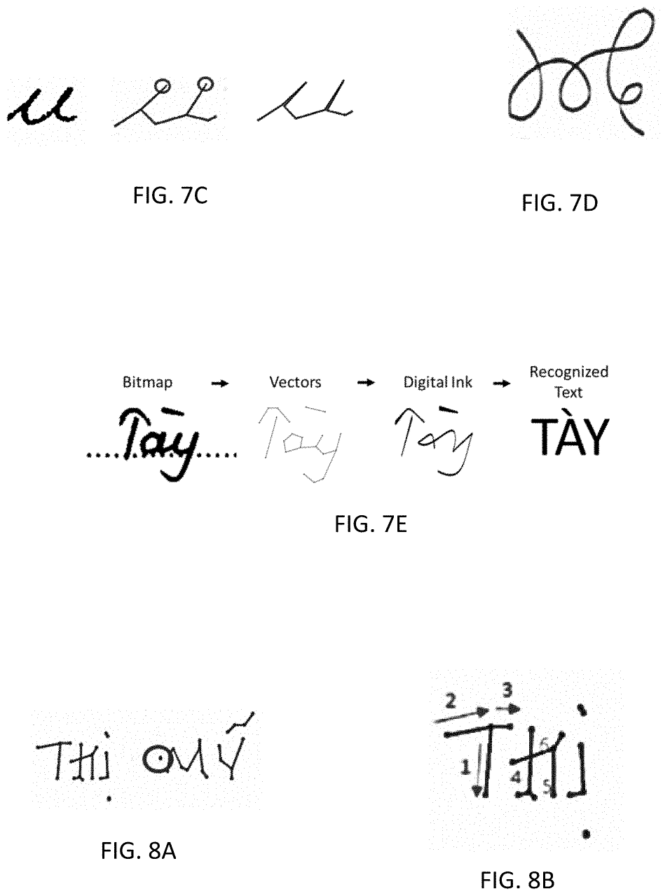

The present invention may comprise the following process step in a case of analyzing and digitizing a text string, as illustrated in FIG. 6A-6C, and further in FIG. 7A-7D.

In FIG. 6A the text line to be examined is defined, and everything outside the selected floor and roof is removed. Then all dotted lines are removed as identified in FIG. 6B.

FIG. 6C illustrates the resulting liquid ink string fed into the vectorization module.

When the text string is cleaned up the vectorization module analyses the string and partitions the string into individual vectors, and further decides where the lines connected as hooks or arcs are broken up into new segments, as illustrated in FIGS. 7A and 7B.

If for example the text is in italic script, then it is necessary to identify and connect pen turning points, by adding additional lines if needed. FIG. 7C illustrates 2 such turning points, and the side walls of the “u” must be drawn in two directions.

When all the concatenated vectors are analyzed, and loops are detected, turning points detected and additional lines added, it is possible to define a smooth representation of the text portion, which represents the analyzed text, and which do have detailed information about a simulated digital ink movement pattern, FIG. 7E.

Before converting the text to digital ink, it may be necessary to clean the text for remaining small fragments and remove suspected noise that does not have any representation in the special database provided for the specific alphabet characteristics of the analyzed text. One example of such task is shown in FIG. 8 and the result after cleaning is shown in FIG. 8B where also the stroke movement is indicated.

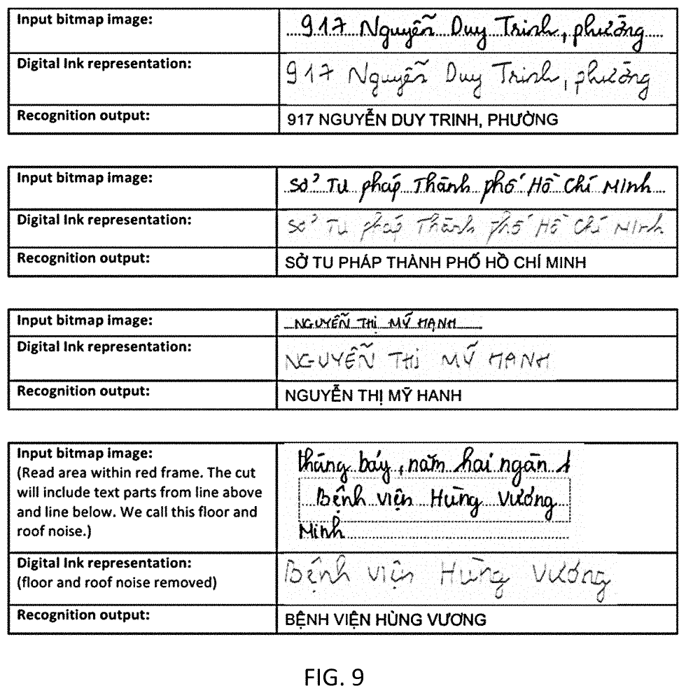

Using the invention on a selected number of Vietnamese text strings are shown in FIG. 9.

It shall also be understood that the invention may be used for analyzing any type of hand written ink, also hand written geometrical shapes. The converted strokes may be sent to a suitable engine and return transformed shapes like rectangles, triangles, circles, lines or arrows.

The present invention will open up the possible use of all utilities and applications offered in the Digital Ink domain to the analyzed Liquid Ink on paper output from present invention.

Concrete example applications enabled by the present invention are mobile translation services, enablement of search engines to index hand written text, analyzing exam result of a written exam where text and figures are converted and cleaned up before the sensors mark a digital representation of the papers.

A typical scenario can be using a phone to snap an image from a white board, and then get it translated to text and figures ready to be edited on a computer.

The invention is not limited by the embodiments shown in the description and text, it is the attached claims that defines the scope of the invention.

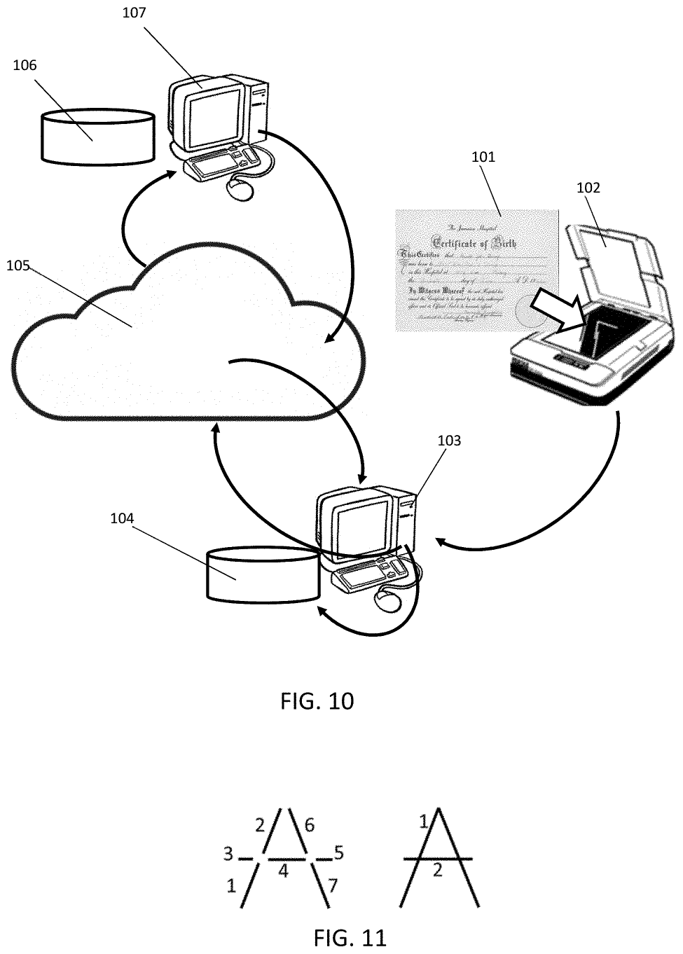

A system for taking advantage of the above discussed method is illustrated in one example embodiment in FIG. 10, and may be comprised of a computer based system 103 comprising processing means and programs for executing the method of the invention, and optional programs for analyzing digital ink, and to store the result in a memory storage device 104, 106, the memory device may be a local memory device 104 connected to the computer based system, or the memory device may be a memory resource 106 arranged in an network or cloud environment 105.

The system will analyze an image of a handwritten material 101, the handwritten material may be stored in a local or network/cloud based memory storage device 104, 106, or directly provided by a scanner 102 connected to the computer system. The handwritten material 101 may comprise only handwritten material or a mix of handwritten material and digital images. The handwritten material may be letters, signs, words and figures, or a combination of one or more of those.

In one embodiment of the system the analyzing sequence of the present invention will be set up to analyze predefined regions of the material 101, for example when forms are analyzed, only the segments where text is inputted into the form may be set up to be analyzed. In another embodiment, the analyzing sequence of the present invention may comprise a detection module which detects which regions of the material contain handwritten material.

Once the analyzing modules of present invention has detected, read, analyzed and built the stroke paths of the analyzed regions, the stroke paths are fed into the digital ink tool which will be able to generate a digital ink representation of the analyzed liquid ink.

The output from the digital ink module, or the stroke paths raw data from the analyzed regions may be stored in a computer memory storage 104, 106, either local to the computing resources 103 or in the network/cloud memory storage 106.

The invention may be described as a first method embodiment for transforming liquid ink to digital ink, wherein liquid ink is any type of handwritten text or figures and digital ink is any type of digital representation of text or figures comprising stroke parameters and sequence order, wherein the method comprising the steps:
generating a scan image by scanning a document comprising liquid ink,
segmenting the scan image in one or more segment to be transformed,
vectorizing the liquid ink in each one or more segment using a predefined vector format,
analyzing the vectors of each segment, and building individual strokes by concatenating each vector having coordinates indicating overlapping vector coordinates, and define each following vector by defining its starting point in the overlapping coordinates with the previous vector,
analyzing the strokes determining the stroke order according to predefined stroke order algorithm,
the stroke analyzing further comprising determining a start point and direction of writing for each stroke.

A second method embodiment according to the first method embodiment, wherein the method further comprise:
formatting the strokes according to a predefined digital ink tool format.

A third method embodiment according to the second method embodiment, wherein the method further comprise:
converting the formatted strokes to text string or figures using the predefined digital ink tool,
outputting the digital representation of the text or figure.

A fourth method embodiment according to the first method embodiment, wherein the analyzing of the strokes further comprise:
comparing one or more strokes to one or more predefined set of language parameters.

A fifth method embodiment according to any of the first to fourth method embodiment, wherein the building of strokes further comprising:
adding vectors binding an end point of the previous vector to the beginning of the following vector if the second vector overlap first vector between the start point and end point of the first vector, thereby defining a continuous stroke path.

A sixth method embodiment according to the first method embodiment, wherein the analyzing of the strokes further comprise:
identifying loops in the stroke, and
determining starting point of the stroke relative the loops.

The invention can also be described as a first system embodiment for transforming liquid ink to digital ink, wherein liquid ink is any type of handwritten text or figures and digital ink is any type of digital representation of text or figures, wherein the system comprising:
computing means comprising a digital storage and program modules,
a scanner for providing a scanned image of the liquid ink or a pre-stored image of the liquid ink,
one of the program modules being a segmentation module able to extract segments of liquid ink from the scanned image,
one of the program modules being a vectorization module able to vectorize each extracted segment of liquid ink, one of the program modules being an analyze and stroke building module able to build strokes according to any of the first to sixth method embodiments.

A second system embodiment according to the first system embodiment, wherein one of the program modules being a digital ink recognition engine able to analyze the output from the analyze and stroke building modules, and
an output module for outputting the digital ink representation of the extracted segments.

A third system embodiment according to the second system embodiment, wherein the system further comprise a database for storing the output of the output module for outputting the digital ink representation of the extracted segments.

A third system embodiment according to the second system embodiment, wherein the database is comprised in the digital storage of the computing means.

A fourth system embodiment according to any of the second or third system embodiment, wherein the system further comprise a cloud based server system wherein the database is arranged in the cloud based server system.

A fifth system embodiment according to any of the first to fourth system embodiment, wherein the analyze and stroke building module also comprise one or more of a character set or figure set, or one or more of a character set and one or more of a figure set.

1. A method for transforming liquid ink to digital ink, wherein liquid ink is any type of handwritten text or figures and digital ink is any type of digital representation of text or figures comprising stroke parameters and sequence order, wherein the method comprises:
generating a scan image by scanning a document comprising liquid ink,
segmenting the scan image in one or more segment to be transformed,
vectorizing the liquid ink in each one or more segment using a predefined vector format,
analyzing the vectors of each segment, and building individual strokes by concatenating each vector having coordinates indicating overlapping vector coordinates, and define each following vector by defining its starting point in the overlapping coordinates with a previous vector,
analyzing the strokes determining the stroke order according to predefined stroke order algorithm,
the stroke analyzing further comprising determining a start point and direction of writing for each stroke.

2. The method for transforming liquid ink to digital ink according to claim 1, wherein the method further comprises:
formatting the strokes according to a predefined digital ink tool format.

3. The method for transforming liquid ink to digital ink according to claim 2, wherein the method further comprises:
converting the formatted strokes to text string or figures using the predefined digital ink tool,
outputting the digital representation of the text or figure.

4. The method for transforming liquid ink to digital ink according to claim 1, wherein the analyzing of the strokes further comprises:
comparing one or more strokes to one or more predefined set of language parameters.

5. The method for transforming liquid ink to digital ink according to claim 1, wherein the building of strokes further comprises:
adding vectors binding an end point of the previous vector to the beginning of the following vector if the second vector overlap first vector between the start point and end point of the first vector, thereby defining a continuous stroke path.

6. The method for transforming liquid ink to digital ink according to claim 1, wherein the analyzing of the strokes further comprises:
identifying loops in the stroke, and
determining starting point of the stroke relative the loops.

7. A system for transforming liquid ink to digital ink, wherein liquid ink is any type of handwritten text or figures and digital ink is any type of digital representation of text or figures, wherein the system comprises:
a computing system comprising a digital storage and program modules,
a scanner for providing a scanned image of the liquid ink or a pre-stored image of the liquid ink,
one of the program modules being a segmentation module able to extract segments of liquid ink from the scanned image,
one of the program modules being a vectorization module able to vectorize each extracted segment of liquid ink,
one of the program modules being an analyze and stroke building module able to build strokes according to the method of claim 1.

8. The system for transforming liquid ink to digital ink according to claim 7, wherein:
one of the program modules being a digital ink recognition engine able to analyze the output from the analyze and stroke building modules, and
an output module for outputting the digital ink representation of the extracted segments.

9. The system for transforming liquid ink to digital ink according to claim 8, wherein the system further comprises a database for storing the output of the output module for outputting the digital ink representation of the extracted segments.

10. The system for transforming liquid ink to digital ink according to claim 9, wherein the database is comprised in the digital storage of the computing system.

11. The system for transforming liquid ink to digital ink according to claim 9, wherein the system further comprises a cloud based server system wherein the database is arranged in the cloud based server system.

12. The system for transforming liquid ink to digital ink according to claim 7, wherein the analyze and stroke building module further comprises one or more of a character set or figure set, or one or more of a character set and one or more of a figure set.
